(19) United States
(12) Patent Application Publication
(10) Pub. No.: US 2007/0101101 A1
(43) Pub. Date: May 3, 2007

(54) Microprocessor

(76) Inventors: Hiroyuki Odahara, Osaka (JP); Toshifumi Hamaguchi, Osaka (JP); Shinya Muramatsu, Hyogo (JP)

Correspondence Address: MCDERMOTT WILL & EMERY LLP, 600 13TH STREET, N.W., WASHINGTON, DC, 20005-3096, US

(21) Appl. No.: 11/584,515

(22) Filed: Oct. 23, 2006

(30) Foreign Application Priority Data
Oct. 31, 2005 (JP) 2005-317158

(51) Int. Cl. G06F 9/30

(52) U.S. Cl. 712/210

(57) ABSTRACT

In a microprocessor that interprets instructions where a same instruction code can be interpreted as separate instructions with respectively different data lengths, a data length storage circuit that stores data length selection-use information is provided in a decoding unit. Instructions instructing storage to a general-purpose register, such storage of 8-bit immediate data to register R1, are set in advance as first-type instructions. Instructions that do not explicitly specify a data length, in other words, instructions whose processing targets are various lengths of data stored in the general-purpose register are set in advance as second-type instructions. When decoding a first-type instruction, the decoding unit updates the data length selection-use information in accordance with the first-type instruction. When decoding a second-type instruction, the decoding unit specifies the data length by referring to the data length selection-use information, and decodes the second-type instruction based on the specified data length.

### BACKGROUND OF THE INVENTION

(1) Field of the Invention

The present invention relates to a microprocessor, and in particular to an instruction interpreting method.

(2) Description of the Related Art

Conventional microprocessors commonly have an interpretable instruction set that includes instruction codes that each correspond to a plurality of word lengths.

The word length is the length of processing target data of an instruction, and is set with respect to each instruction code.

Taking an example of specifying processing for adding together respective numeric data of two different registers and storing the result to a certain register, different instruction codes are used depending on whether the numeric data is processed as 1-byte data, 2-byte data, or 4-byte data.

However, having to provide a plurality of instruction codes for the various lengths of processing target data (i.e. instruction codes having respectively different bit sequences) regardless of the processing content being identical to an extent is not desirable when using a fixed length instruction format that expresses instructions with a limited number of bits. This is because provide a plurality of instruction codes for the various lengths of processing target data prevents a variety of instructions, in other words numerous types of instructions, from being included in the instruction set.

One technique relating for solving this problem is proposed in Japanese Patent Application Publication No. 2004-206214. With this technique, the relationship between data length and the address range in the data memory accessed by instructions is set in advance. When the microprocessor interprets (decodes) instructions, even for the same instruction code, it switches the data length based on the address to access in the data memory.

With the aforementioned microprocessor, since the same instruction code can be interpreted as separate instructions that each target a different length of data, it is unnecessary to provide a bit field for identifying the data length in the instruction code.

### SUMMARY OF THE INVENTION

The present invention has an object of providing a microprocessor that is capable of interpreting a same instruction code as separate instructions that each target a different length of data, in a different manner to the technique disclosed by Japanese Patent Application Publication No. 2004-206214.

In order to achieve the stated object, the microprocessor of the present invention successively reads instructions, and interprets and executes each read instruction, including: a storage unit operable to store data length selection-use information showing a length of processing target data; a decoding unit operable to successively perform instruction interpreting processing with respect to the instructions to specify, for each instruction, contents of instruction executing processing to be performed in accordance with the instruction; and an execution unit operable to perform, with respect to each instruction, the instruction executing processing in accordance with the contents specified as a result of the instruction interpreting processing for the instruction, wherein when a target of the instruction interpreting processing is any one of first-type instructions, the decoding unit updates the stored data length selection-use information in accordance with the first-type instruction, and when the target of the instruction interpreting processing is any one of second-type instructions, the decoding unit selects a length of processing target data of the second-type instruction in accordance with the stored data length selection-use information, and performs the instruction interpreting processing in accordance with the selected length.

Here, as one example, the storage unit is a storage circuit that stores data length selection-use information, in other words, the storage circuit is a data length storage circuit. The decoding unit is, for example, an instruction decoder, a first-type instruction corresponding circuit, and a second-type instruction corresponding circuit. Here, the instruction decoder executes various control necessary to decode. The first-type instruction corresponding circuit has a function of, if the instruction code that is the decoding target is a first-type instruction, updating the contents of the data length storage circuit in accordance with the first-type instruction. The second-type instruction corresponding circuit has a function of, if the instruction code that is the decoding target is a second-type instruction, referring to the contents of the data length storage circuit to specify the length of the data that is to be the target of processing corresponding to the instruction code of the second-type instruction, and conveying the data length to the instruction decoder. Furthermore, the execution unit is, for example, an interface unit that is a circuit including (i) an arithmetic unit that is a circuit for performing various types of calculations, such as addition and multiplication, with respect to data stored in a general-purpose register or data stored in a data memory, and (ii) a bus, and having a function of controlling transfer of data between the general-purpose register, the arithmetic unit, the data memory, and so on.

With the stated structure, when decoding an instruction that is a second-type instruction, the microprocessor of the present invention specifies, according to the data length selection-use information updated when the preceding first-type instruction was decoded, what length of data the processing target of the instruction code of the second-type instruction is, and performs decoding of the second-type instruction based on the specified data length. This makes it possible to interpret a same instruction code as a plurality of instructions that target data of respectively different lengths for processing, and eliminates the need to provide a bit field for explicitly identifying the data length in the instruction code of second-type instructions. This leaves more room for a variety instructions to be included in the instruction set when using a fixed bit length format.

Note that the first-type instructions may include instructions that have a bit field for identifying the data length in the instruction code. Examples of such instructions include an instruction for transferring one byte (8 bits) of data from a memory to a register, and an instruction for transferring two bytes (16 bits) of data from a memory to a register.

Furthermore, the microprocessor of the present invention performs updating and referencing of the data length selection-use information not at the instruction executing processing stage, but when performing instruction interpreting processing. Therefore, even if employing a pipeline structure in which each of instruction reading (fetching), instruction interpretation (decoding) and execution are separate pipeline stages, when a second-type instruction directly proceeds a first-type instruction, the data length selection-use information updated in accordance with the first-type instruction can be used at the decoding stage of the second-type instruction.

Here, the first-type instructions may include a data storage instruction that instructs storing data of a first length to a register, and a data storage instruction that instructs storing data of a second length to a register, and when the target of the instruction interpreting processing is either of the data storage instructions, the decoding unit may update the stored length selection-use information so as to show the one of the first and second lengths that pertains to the one of the data storage instructions that is the target.

With the stated structure, when decoding various types of instructions for storing data to a register, for instance an instruction for reading data stored in a particular number of bytes in a specific location and storing the read data to a register, the storage contents of the data length selection-use information are determined and updated in parallel with the decoding, based on the decoded instruction, more specifically, based on the length of data set in the register by the decoded instruction. In other words, in addition to being instructions for storing general data to a register, first-type instructions also have a function of updating the data length selection-use information. Therefore, in terms of the program interpreted and executed by the microprocessor, the need to include specific instructions or the like whose sole purpose is updating the storage contents of the data length selection-use information is eliminated.

Furthermore, a general program, when viewed locally, is structured such that directly or slightly after an instruction for storing data in a register, an instruction is executed whose processing target for calculation, transfer or the like is the data that was stored in the register. Therefore, if instructions for which the data length of the calculation target data is selectable are set appropriately as second-type instructions in advance, this basically enables the data length in second-type instructions to be selected appropriately. In other words, this eliminates the need to provide a separate instruction for each data length that is calculation target in the instruction set supported by the microprocessor.

Note that as an exception, in the case of a program that is structured in a manner that the data length is not selected appropriately, such as a program in which a complicated mixture of lengths of data to be processed exists, this may be dealt with by, for instance, providing specific instructions for updating the storage contents of the data length selection-use information. In this case, by making the number of second-type instructions in the instruction set supported by the microprocessor greater than the number of the specific instructions in the instruction set, the number of instructions required for updating the storage contents of the data length selection-use information can be reduced. This leaves more room for a variety instructions to be included in the instruction set when using a fixed bit length format.

Here, the first-type instructions may include (i) an instruction that instructs setting of an n-bit value in a register, (ii) an instruction that instructs setting of a 2n-bit value in a register, (iii) an instruction that instructs transfer of n bits of data from a memory to a register, and (iv) an instruction that instructs transfer of 2n bits of data from the memory to a register, and when the target of the instruction interpreting processing is the instruction that instructs setting of an n-bit value in a register, the decoding unit may update the stored data length selection-use information to show n bits, when the target of the instruction interpreting processing is the instruction that instructs setting of a 2n-bit value in a register, the decoding unit may update the stored data length selection-use information to show 2n bits, when the target of the instruction interpreting processing is the instruction that instructs transfer of n bits of data from a memory to a register, the decoding unit may update the stored data length selection-use information to shown bits, and when the target of the instruction interpreting processing is the instruction that instructs transfer of 2n bits of data from a memory to a register, the decoding unit may update the stored data length selection-use information to show 2n bits.

Take the example of a particular instruction whose preceding instruction in the program is for setting an immediate value designated by an operand in a register or for transferring data from the memory to the register, and whose processing target for calculation, transfer or the like is assumed to be data in the register of a length that is the same as the size set by the preceding instruction. With the stated structure, an instruction such as the described particular instruction can be set as a second-type instruction that does not explicitly specify the length of handled data. This eliminates the need to provide a separate instruction for each calculation target data length in the instruction set supported by the microprocessor.

Here, at least one of the instructions may be a multiplication instruction that is included in both the first-type instructions and the second-type instructions, and when the target of the instruction interpreting processing is the multiplication instruction, the decoding unit may select a length of processing target data of the multiplication instruction in accordance with the stored data length selection-use information to perform the instruction interpreting processing in accordance with the selected length, and update the stored data length selection-use information to show a predetermined value.

Assume an example of the data length selection-use information showing a data length of one byte, due to the microprocessor having decoded, for instance, an instruction for storing one byte of data to a register. Now assume that the microprocessor decodes a multiplication instruction that instructs multiplication of the contents of a particular register with the contents of another register. Here, the data input into each of the registers is treated as having a length of one byte, but the product of the two one-byte data is expressed as two bytes. The stated microprocessor is capable of handling this situation, enabling the second-type instruction, which is after the multiplication instruction and whose processing target is the product of the multiplication instruction, to be processed as data with a length of two bytes.

Here, the data length selection-use information may selectively show one of a plurality of lengths, and each time the decoding unit performs the instruction interpreting processing for any of the first-type instructions, the decoding unit may update the data length selection-use information so as to show a next one of the plurality of lengths in a predetermined cyclic order of the plurality of lengths.

This structure enables, for instance, the data length shown by the data length selection-use information to transition cyclically in a pattern such as 1 byte, 2 bytes, 4 bytes, 1 byte, 2 bytes, 4 bytes, 1 byte, each time the microprocessor decodes, as a first-type instruction, a NOP instruction that is a conventional NOP instruction indicating that no particular processing is to be executed. Therefore, the data length selection-use information can be updated to show an arbitrary data length by, for instance, inserting the necessary number of NOP instructions in the necessary places in the program. This eliminates the need to provide a plurality of instructions for setting the data length selection-use information to show specific values in the instruction set. Note that it is not imperative for the first-type instruction to be a conventional NOP instruction.

Here, the microprocessor may further include a plurality of registers that are able to be designated as storage locations of processing target data by instructions, wherein the storage unit stores a plurality of pieces of the data length selection-use information that correspond respectively to the plurality of registers, the first-type instruction is an instruction that instructs storing of data of a certain length to a certain one of the registers, the second-type instruction is an instruction that instructs performing calculation processing with respect to, as the processing target data, data stored in a certain one of the registers and being of a certain length, and when the target of the instruction interpreting processing is the first-type instruction, the decoding unit updates the piece of data length selection-use information corresponding to the register to which storing of data is instructed by the first-type instruction, and when the target of the instruction interpreting processing is the second-type instruction, the decoding unit selects a length of the processing target data of the second-type instruction in accordance with the piece of data length selection-use information corresponding to the register designated by the second-type instruction as storing the processing target data, and specifies the contents of the instruction executing processing for the second-type instruction such that the calculation processing is performed with respect to the selected length's worth of the processing target data.

According to the stated structure, a data length is stored for each register that the microprocessor has for storing data that is the processing target of calculation, transfer and the like. These data lengths are updated by a first-type instruction, and then referred to when a second-type instruction is decoded. Therefore, this structure is effective when the program executed is one such as a program that handles data of different lengths. As one example, assume that the following instructions are arranged in the stated order in the program: an instruction for storing one-byte immediate value data in a first register (one-byte value storage instruction), an instruction for storing two-byte immediate value data in a second register (two-byte value storage instruction), an instruction that targets the contents of the first register for processing such as a calculation, and an instruction that targets the contents of the second register for processing such as a calculation. Regardless of not being instructions that explicitly specify a data length, the latter two of these four instructions are decoded as an instruction that targets the contents of the first register for processing as a one-byte value, and an instruction that targets the contents of the second register for processing as a two-byte value.

Here, the microprocessor may further include a plurality of registers that are able to be designated as storage locations of processing target data by instructions, wherein the storage unit further stores a plurality of pieces of validity information that correspond respectively to the plurality of registers, each piece of validity information showing whether to treat the data length selection-use information as valid or invalid in the instruction interpreting processing, the first-type instruction is an instruction that instructs storing of data of a certain length to a certain one of the registers, the second-type instruction is an instruction that instructs performing calculation processing with respect to, as the processing target data, data stored in a certain one of the registers and being of a certain length, and when the target of the instruction interpreting processing is the first-type instruction, in addition to updating the data length selection-use information in accordance with the first-type instruction, the decoding unit updates, to show valid, the piece of validity information corresponding to the register to which storage of data is instructed by the first-type instruction, when the target of the instruction interpreting processing is a third-type instruction, the decoding unit updates, to show invalid, a piece of validity information corresponding to a certain one of the registers, in accordance with the third-type instruction, and when the target of the instruction interpreting processing is the second-type instruction, (a) (i) if the piece of validity information corresponding to the register designated by the second-type instruction as storing the processing target data shows valid, the decoding unit selects a length of the processing target data in accordance with the data length selection-use information, (ii) if the piece of validity information corresponding to the register designated by the second-type instruction as storing the processing target data shows invalid, the decoding unit selects a predetermined length as a length of the processing target data, and (b) the decoding unit specifies the contents of the instruction executing processing for the second-type instruction such that the calculation processing is performed with respect to the selected length's worth of the processing target data.

When the microprocessor is executing a program that, for instance, handles one-byte data as a processing target, the data length selection-use information basically shows the data length as being one byte. Assume, however, that the program includes not only a part used for storing one byte of data in one of the general-purpose registers, but also a part used for storing, for instance, a 4-byte memory address value in the general-purpose register. If an instruction such as that for using a general-purpose register to store a memory address is set as a third-type instruction, the microprocessor is able to decode so as to set the data length with respect to general-purpose register specified by the third-type instructions without referring to the data length selection-use information. Therefore, the microprocessor is also suitable for execution of a program that uses a particular register alternately for storing a predetermined data length and storing a memory address.

### BRIEF DESCRIPTION OF THE DRAWINGS

These and other objects, advantages and features of the invention will become apparent from the following description thereof taken in conjunction with the accompanying drawings which illustrate a specific embodiment of the invention.

In the drawings:

FIG. 1 is a structural drawing of a microprocessor 100 of a first embodiment of the present invention;

FIG. 2 shows storage contents of a data length storage circuit 119;

FIG. 3 shows the instruction format of an instruction decodable by the microprocessor 100;

FIG. 4 shows an example of a first-type instruction that is a processing target of a first-type instruction corresponding circuit 112;

FIG. 5 shows an example of a second-type instruction that is a processing target of a second-type instruction corresponding circuit 113;

FIG. 6 is a flowchart showing operations by the microprocessor 100;

FIG. 7 is a flowchart showing instruction interpreting processing performed by a decoding unit 110;

FIG. 8 shows an example of a program interpreted by the microprocessor 100;

FIG. 9 shows transition in the data length selection-use information based on decoding of instructions;

FIG. 10 is a structural diagram of a microprocessor 200 of a second embodiment of the present invention;

FIG. 11 shows the storage contents of the data length storage circuit 219; and

FIG. 12 is a flowchart showing instruction interpreting processing performed by a decoding unit of a modified microprocessor.

### DESCRIPTION OF THE PREFERRED EMBODIMENTS

### 1. First Embodiment

The following describes a microprocessor 100 of a first embodiment of the present invention.

1-1. Structure

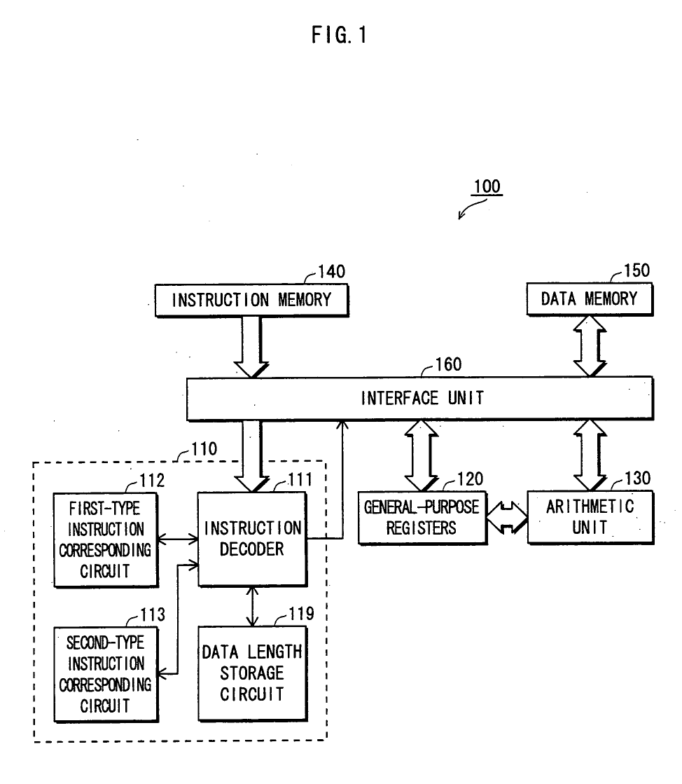

FIG. 1 is a structural diagram of the microprocessor 100 of the first embodiment of the present invention.

The microprocessor 100 is an integrated circuit that fetches, decodes and executes instruction codes that belong to an instruction set having a fixed length instruction format. As shown in FIG. 1, the microprocessor 100 is composed of a decoding unit 110, general-purpose registers 120, an arithmetic unit 130, an instruction memory 140, a data memory 150 and an interface unit 160.

The general-purpose registers 120 are data storage circuits for temporarily storing data that is a processing target or a processing result of a calculation, a transfer, or the like. More specifically, the general-purpose registers 120 are a collection of eight registers (register R0 to register R7) that are each capable of storing 32 bits of data.

The arithmetic unit 130 is a circuit for performing various types of calculations such as addition and multiplication with data stored in the general-purpose registers 120 or data stored in the data memory 150 as the processing target.

The instruction memory 140 is a memory for storing an instruction stream that makes up a program that is a target of execution.

The data memory 150 is a rewritable memory that data is written to and read from when instructions are executed.

The interface unit 160, which includes a bus, is a circuit that has a function of controlling data transfer between the data memory 150 and the general-purpose registers 120 and between the data memory 150 and the arithmetic unit 130, and a function of controlling transfer of instruction codes from the instruction memory 140 to the decoding unit 110.

The decoding unit 110 has a function of determining, based on each of instruction codes successively read from the instruction memory 140, how to control the arithmetic unit 130 and the interface unit 160 to operate in accordance with the instruction code, and transmitting a control signal to the interface unit 160 to have the control performed. In other words, the decoding unit 110 is a circuit having a function of decoding instructions. As shown in FIG. 1, the decoding unit 110 has an instruction decoder 111, a first-type instruction corresponding circuit 112, a second-type instruction corresponding circuit 113 and a data length storage circuit 119.

The instruction decoder 111 is a circuit that executes various control necessary to decode instructions.

The data length storage circuit 119 is a storage circuit that stores data length selection-use information that shows a length of data that is a processing target of calculation, data transfer or the like.

The first-type instruction corresponding circuit 112 is a circuit having a function of, when the instruction code that is the decoding target is a first-type instruction, updating the contents of the data length storage circuit 119 in accordance with the contents of the first-type instruction. Note that details of first-type instructions are given later.

The second-type instruction corresponding circuit 113 is a circuit having the function of, when the instruction code that is the target of decoding is a second-type instruction, referring to contents of the data length storage circuit 119 to specify the length of data that is a target of processing corresponding to the instruction code of the second-type instruction, and conveying the specified data length to the instruction decoder 111 to cause the instruction decoder 111 to decode in accordance with the data length. Note that details of second-type instructions are given later.

1-2. Data

The following describes the data length selection-use information and the various instructions used in the microprocessor 100.

1-2-1. Data Length Selection-Use Information

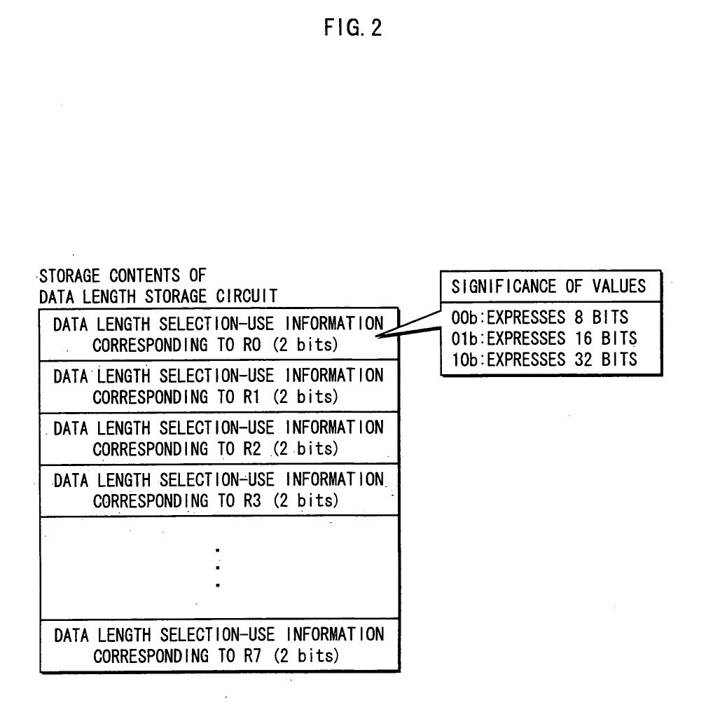

FIG. 2 shows the storage contents of the data length storage circuit 119.

As shown in FIG. 2, the data length storage circuit 119 stores data length selection-use information, each piece of which is two bits and corresponds to a different one of the general-purpose registers 120. Specifically, a total of 16 bits of information, consisting of data length selection-use information corresponding to the register R0 through to data length selection-use information corresponding to the register R7 are stored by the data length storage circuit 119.

The significance of the values in the two-bit data length selection-use information is as follows: two-bit long 00b (“b” denotes binary notation) indicates an data length of 8 bits (1 byte), 01b indicates a data length of 16 bits (2 bytes), and 10b indicates a data length of 32 bits (4 bytes).

1-2-2. Instruction Format

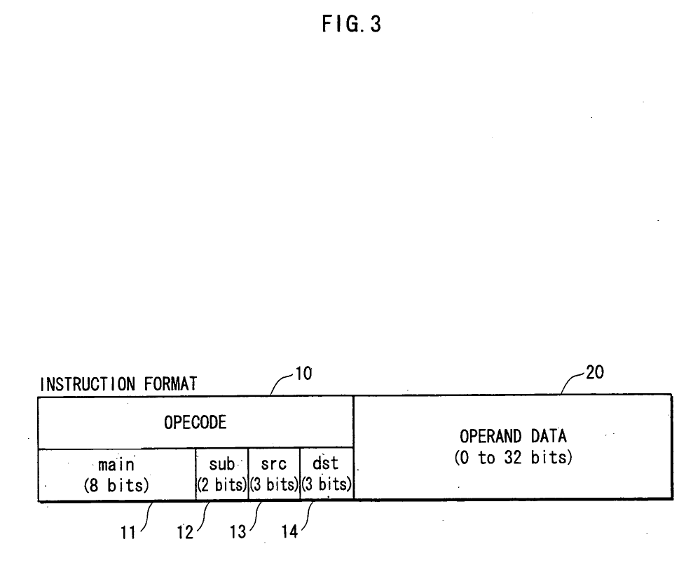

FIG. 3 shows the instruction format of an instruction decodable by the microprocessor 100.

As shown in FIG. 3, the instruction is composed of a 16-bit opcode field 10 for identifying the instruction code, and an operand data field 20 that is set to a predetermined size of 0 bits to 32 bits, depending on the instruction code.

The opcode field 10 is composed of an 8-bit main field 11 (main), a 2-bit sub field 12 (sub), a 3-bit source register field 13 (src) and a 3-bit destination register field 14 (dst) The main field 11 is for identifying the basic instruction type, the sub field 12 is for identifying the detailed instruction type or the data length, and the source register field 13 and the destination register field 14 each designate one of the general-purpose registers 120 as a processing target.

1-2-3. First-Type Instructions

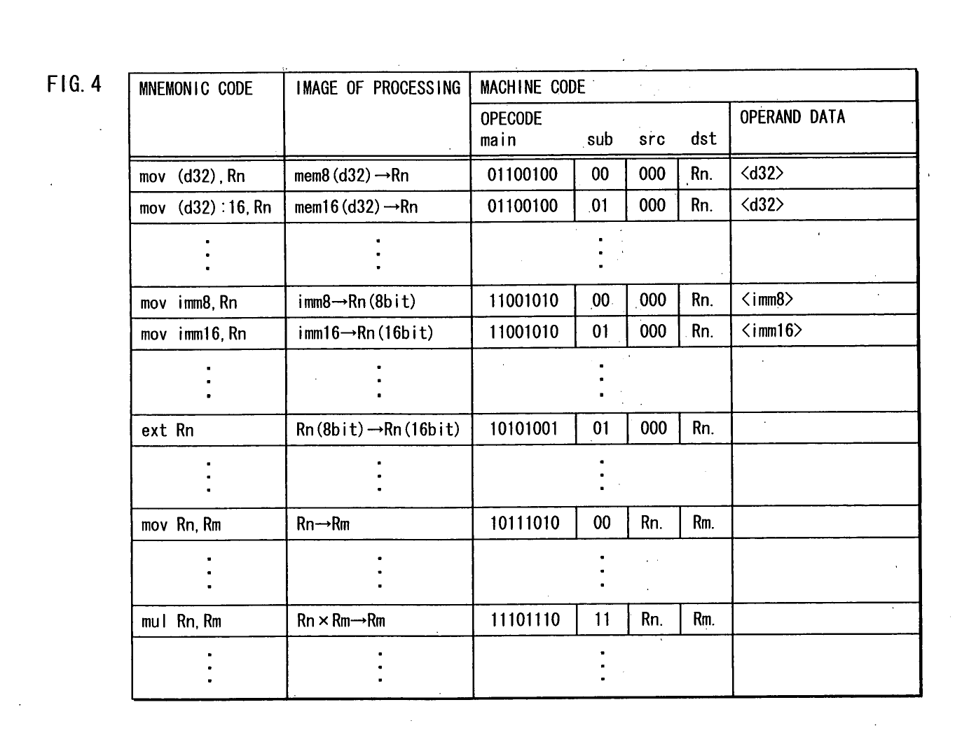

FIG. 4 shows examples of first-type instruction codes that are a processing target of the first-type instruction corresponding circuit 112.

The following describes the significance of each first-type instruction shown in FIG. 4 using mnemonic code, and how the first-type instruction corresponding circuit 112 updates the data length selection-use information in response to each instruction.

(a) A move instruction “mov (d32), Rn” is an instruction instructing transfer of 8 bits of data that is at a location, in the data memory 150, shown by a memory address designated in the 32-bit (4-byte) operand data field, to the one of the registers R0 to R7 shown by the destination register field. When this mov instruction is the target of decoding, the first-type instruction corresponding circuit 112 updates the data length selection-use information corresponding to the general-purpose register designated in the destination register field of the mov instruction, to a value indicating 8 bits (00b).

(b) A move instruction “mov (d32): 16, Rn” is an instruction instructing transfer of 16 bits of data that is at a location, in the data memory 150, shown by a memory address designated in the 32-bit operand data field, to the one of the registers R0 to R7 shown by the destination register field. When this mov instruction is the target of decoding, the first-type instruction corresponding circuit 112 updates the data length selection-use information corresponding to the general-purpose register designated in the destination register field of the mov instruction, to a value indicating 16 bits (01b). In terms of contents of the operand field, the only difference between this mov instruction and the aforementioned mov instruction “mov (d32), Rn” is the contents of the sub field (sub) used to identify the data length.

(c) A mov instruction “mov imm8, Rn” is an instruction instructing storing of an immediate value designated by the 8-bit operand data field to the one of the registers R0 to R7 shown by the destination register field. When this mov instruction is the target of decoding, the first-type instruction corresponding circuit 112 updates the data length selection-use information corresponding to the general-purpose register designated in the destination register field of the mov instruction, to a value indicating 8 bits (00b).

(d) A mov instruction “mov imm16, Rn” is an instruction instructing storing of an immediate value designated by the 16-bit operand data field to the one of the registers R0 to R7 shown by the destination register field. When this mov instruction is the target of decoding, the first-type instruction corresponding circuit 112 updates the data length selection-use information corresponding to the general-purpose register designated in the destination registration field of the mov instruction, to a value indicating 16 bits (01b). In terms of the contents of the operand field, the only difference between this mov instruction and the aforementioned mov instruction “mov imm8, Rn” is the contents of the sub field (sub) used to identify the data length.

(e) An ext instruction “ext Rn” is an instruction instructing extending of the contents of the one of the registers R0 to R7 shown by the destination register field, from 8-bit data to 16-bit data. When this ext instruction is the target of decoding, the first-type instruction corresponding circuit 112 updates the data length selection-use information corresponding to the general-purpose register designated in the destination register field of the ext instruction, to a value indicating 16 bits (01b).

(f) A mov instruction “mov Rn, Rm” is an instruction instructing transfer of contents of the one of the registers R0 to R7 shown by the source register field, to the one of the registers R0 to R7 shown by the destination register field. When this mov instruction is the target of decoding, the first-type instruction corresponding circuit 112 updates the contents of the data length selection-use information corresponding to the general-purpose register designated in the destination register field of the mov instruction, such that they are identical to the contents of the data length selection-use information corresponding to the general-purpose register designated in the source register field of the mov instruction.

(g) An mul instruction “mul Rn, Rm” is an instruction instructing multiplying the contents of the one of the registers R0 to R7 shown by the source register field with the contents of the one of the registers R0 to R7 shown by the destination register field, and storing the product that is the result of the multiplication in the general-purpose register shown by the destination register field of the mul instruction. When this mul instruction is the target of decoding, the first-type instruction corresponding circuit 112 updates the contents of the data length selection-use information corresponding to the general-purpose register designated in the destination register field of the mul instruction to show a data length that is twice the data length shown by the contents of the data length selection-use information corresponding to the general-purpose register designated in the source register field of the mul instruction.

Since the first-type instructions are instructions that have a function of specifying the length of data stored in a general register, such as instructions that instruct storing immediate data of a specific length in a general-purpose register and instructions that instruct transferring data of a specific length from the data memory to a general-purpose register, the first-type instructions include other instructions in addition to those shown in FIG. 4. The first-type instruction corresponding circuit 112 updates the data length selection-use information according to a predetermined algorithm with respect to each of these first-type instructions.

1-2-4. Second-Type Instructions

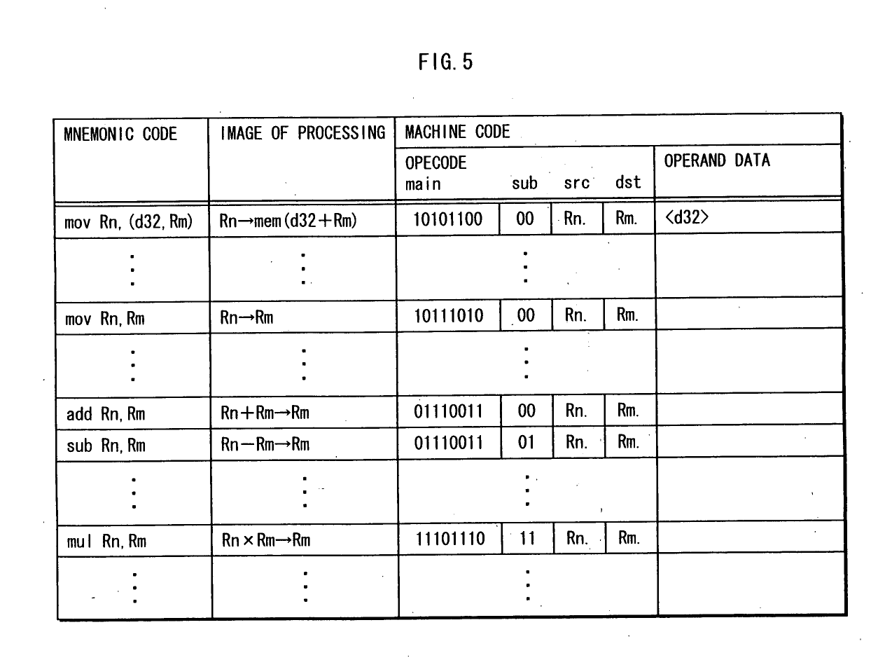

FIG. 5 shows examples of second-type instruction codes that are processed by the second-type instruction corresponding circuit 113.

The following describes the significance of each first-type instruction shown in FIG. 5 using mnemonic code, and how the second-type instruction corresponding circuit 113 determines the data length selection-use information in response to each instruction.

(a) A mov instruction “mov Rn, (d32, Rm)” is an instruction instructing transfer of data of an unspecified length stored in the one of the registers R0 to R7 shown by the source register field, to a location, in the data memory 150, shown by a memory address that is the sum of (i) the memory address value designated in the 32-bit (4-byte) operand data field, and (ii) the value stored in the one of the registers R0 to R7 shown by the destination register field. When this mov instruction is the target of decoding, the second-type instruction corresponding circuit 113 refers to the data length selection-use information corresponding to the general-purpose register designated in the destination register field of the mov instruction, and by selecting the data length shown by this data length selection-use information, specifies the unspecified data length. Note that the data length specified by the second-type instruction corresponding circuit 113 is conveyed to the instruction decoder 111, and the instruction decoder 111 performs control relating to instruction execution on the basis of the processing target of the instruction being the conveyed data length.

(b) The mov instruction “mov Rn, Rm” is a second-type instruction in addition to being a first-type instruction as described earlier. When this mov instruction is the target of decoding, the second-type instruction corresponding circuit 113 specifies the length of the data stored in the general-purpose registers designated by the mov instruction, by selecting the data length shown by the data length selection-use information corresponding to the general-purpose register designated by the source register field in the mov instruction.

(c) An add instruction “add Rn, Rm” is an instruction instructing adding the contents of the one of the registers R0 to R7 shown by the source register field to the contents of the one of the registers R0 to R7 shown by the destination register field, and storing the sum that is the result of the addition to the general-purpose register shown by the destination register field of the add instruction. When this add instruction is the target of decoding, the second-type instruction corresponding circuit 113 specifies the length of the data stored in the general-purpose registers designated by the add instruction, by selecting the data length shown by the data length selection-use information corresponding to the general-purpose register designated by the source register field in the add instruction.

(d) A sub instruction “sub Rn, Rm” is an instruction instructing subtracting the contents of the one of the registers R0 to R7 shown by the destination register field from the contents of the one of the registers R0 to R7 shown by the source register field, and storing the difference that is the result of the subtraction to the general-purpose register shown by the destination register field of the sub instruction. When this sub instruction is the target of decoding, the second-type instruction corresponding circuit 113 specifies the length of the data stored in the general-purpose registers designated by the sub instruction, by selecting the data length shown by the data length selection-use information corresponding to the general-purpose register designated by the source register field in the sub instruction.

In terms of the contents of the opcode fields, this sub instruction differs from the aforementioned add instruction only in terms of the contents of the subfield (sub) used for identifying the detailed instruction type. In the present example, since the add instruction and the sub instruction do not designate a data length, and it is unnecessary to use the sub field (sub) to identify the data length, the sub field (sub) is used to identify the detailed instruction type. This shows that with this method, a larger number of instructions can be included in the instruction set.

(e) The mul instruction “mul Rn, Rm” is a second-type instruction in addition to being a first-type instruction as described earlier. When this mul instruction is the target of decoding, the second-type instruction corresponding circuit 113 specifies the length of the data stored in the general-purpose registers designated by the mul instruction, by selecting the data length shown by the data length selection-use information corresponding to the general-purpose register designated by the source register field in the mul instruction. Note that when decoding a mul instruction, the instruction decoder 111 performs control relating to instruction execution based on the assumption that the length of the data of the result of multiplication is twice the length specified by the second-type instruction corresponding circuit 113.

The second-type instructions are instructions that themselves do not specify the length of data that is a processing target. Other second-type instructions exist in addition to the examples shown in FIG. 5, and the second-type instruction corresponding circuit 113 determines the data length selection-use information according to a predetermined algorithm with respect to each of these second-type instructions.

1-3. Operations

The following describes operations by the microprocessor 100 having the described structure.

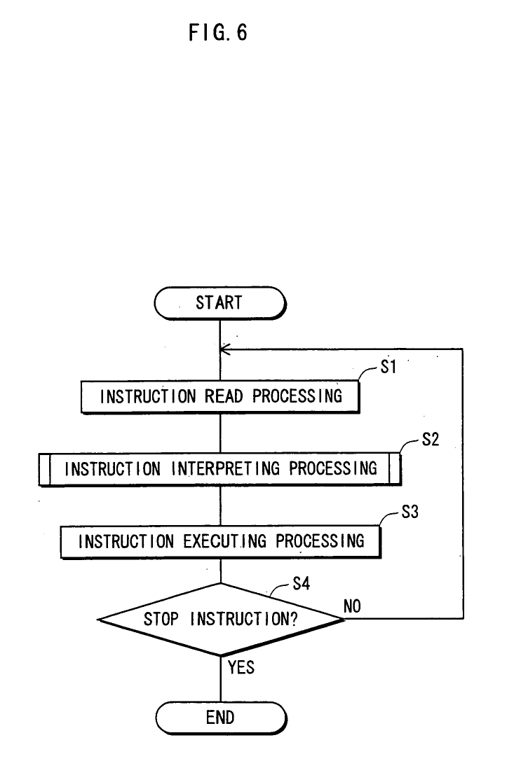

FIG. 6 is a flowchart showing operations by the microprocessor 100.

As shown in FIG. 6, the microprocessor 100 performs the steps of: instruction read processing to read an instruction from the instruction memory 140 and have the read instruction fetched by the decoding unit 110 (step S1), instruction interpreting processing by the decoding unit 110 (step S2), and instruction executing processing for the arithmetic unit 130 and the interface unit 160 to perform execution of the instruction (step S3). The microprocessor 100 repeatedly performs these steps S1 to S3 until a stop instruction occurs due to, for instance, provision of the clock stopping (step S4).

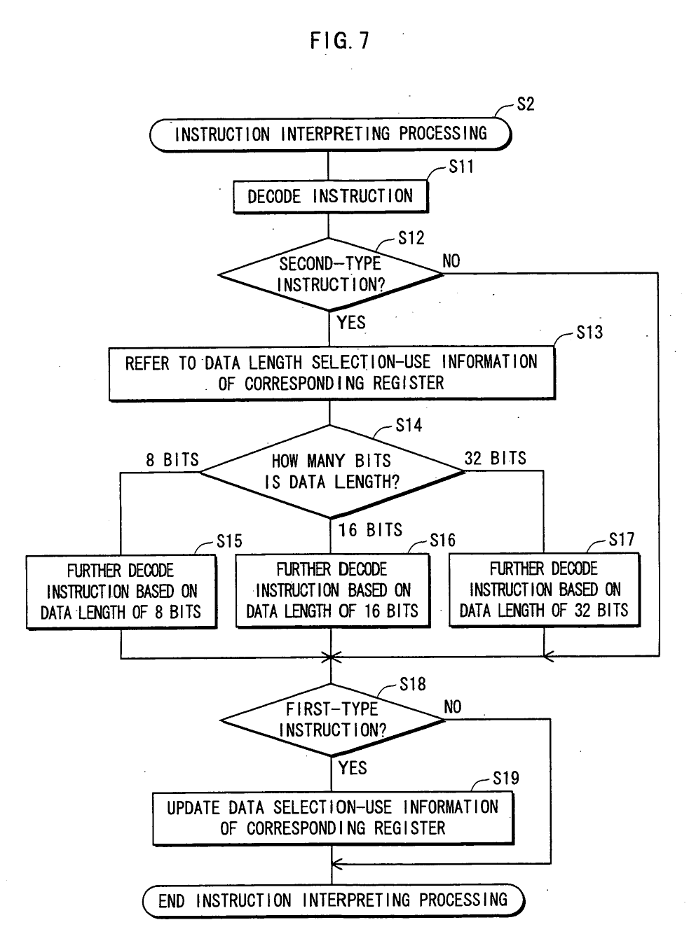

FIG. 7 is a flowchart showing instruction interpreting processing performed by the decoding unit 110.

The decoding unit 110 performs control to cause an instruction read from the instruction memory 140 to be decoded by the instruction decoder 111, to prepare for execution of the instruction (step S11). If the instruction is a second-type instruction (step S12), the decoding unit 110 causes the second-type instruction corresponding circuit 113 to operate. Note that in the decoding at the stage of step S11, control relating to data length is not performed for instructions with an unspecified data length.

The second instruction corresponding circuit 113 refers to the data length selection-use information corresponding to the specific general-purpose register designated in the instruction (step S13), specifies the data length in the manner described earlier (step S14), and conveys the data length to the instruction decoder 111. If the conveyed data length is 8 bits, the instruction decoder 111 further decodes the instruction, treating the instruction as an instruction whose processing target is 8-bit data (step S15). If the conveyed data length is 16 bits, the instruction decoder 111 further decodes the instruction, treating the instruction as an instruction whose processing target is 16-bit data (step S16). If the conveyed data length is 32 bits, the instruction decoder 111 further decodes the instruction treating the instruction as an instruction whose processing target is 32-bit data (step S17).

Next, if the instruction is a first-type instruction (step S18), the instruction decoder 111 causes the first-type instruction corresponding circuit 112 to operate, and the first-type instruction corresponding circuit 112 updates, in the manner described earlier, the data length selection-use information corresponding to the specific general-purpose register designated by the instruction (step S19).

Note that if the instruction read from the instruction memory 140 is not a second-type instruction, the decoding unit 111 does not perform steps S13 to S17, and if the read instruction is not a first-type instruction, the decoding unit does not perform step S19.

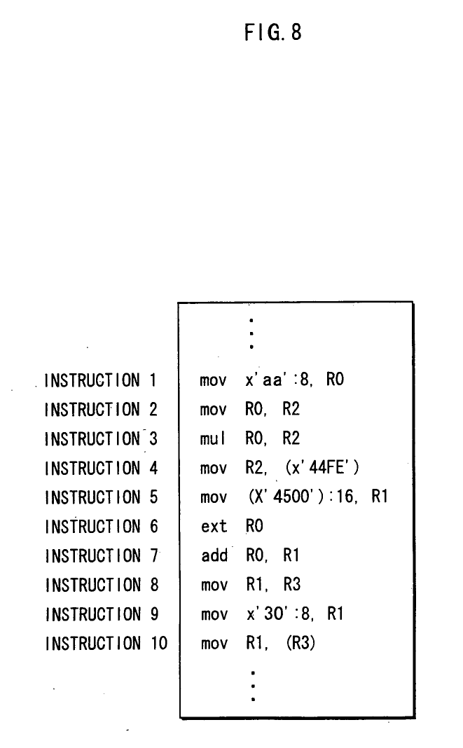

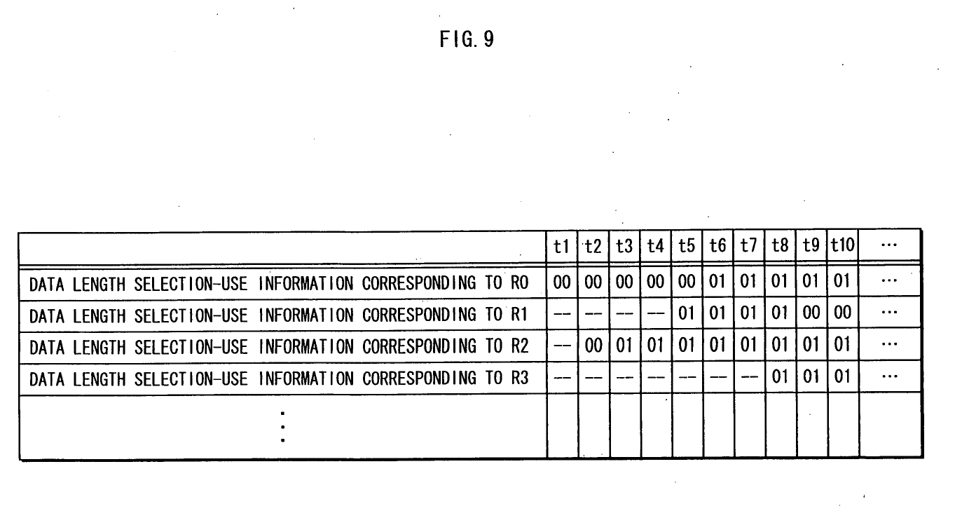

The following describes, with reference to FIG. 8 and FIG. 9, details of operations by the decoding unit 110 for specifying the length of data that is a processing target of an instruction with an unspecified data length.

FIG. 8 shows an example of a program interpreted by the microprocessor 100.

FIG. 9 shows transition in the data length selection-use information based on decoding of instructions. FIG. 9 shows the data length selection-use information corresponding to the general-purpose registers at times t1, t2, t3, etc. which are respective points in time directly after the end of decoding of instruction 1, instruction 2, instruction 3, etc. of FIG. 8.

(a) First, when the decoding unit 110 decodes instruction 1, since instruction 1 is a first-type instruction that instructs storing of an 8-bit immediate value aah (“h” denotes hexadecimal notation) to the register R0, the data length selection-use information corresponding to the register R0 is updated by the first-type instruction corresponding circuit 112 to 00b (“b” denotes binary notation), so as to show an 8-bit data length (see time t1 in FIG. 9).

(b) Next, the decoding unit 110 decodes instruction 2 that instructs transfer of the contents of register R0 whose data length is unspecified, to the register R2. Here, since the data length selection-use information corresponding to the register R0 shows 8 bits, the data length is specified as 8 bits by the second-type instruction corresponding circuit 113, and instruction 2 is decoded as an instruction by which 8 bits of data in the register R0 are transferred to the register R2. Furthermore, contents of the data length selection-use information corresponding to the register R0 are copied as the contents of the data length selection-use information corresponding to the register R2. As a result, the data length selection-use information corresponding to the register R2 become 00b (see t2 in FIG. 9).

(c) Next, the decode unit 110 decodes instruction 3 that instructs multiplication of the unspecified data length contents of register R0 with the contents of register R2, and storing of the product of the multiplication to the register R2. Here, since the data length selection-use information corresponding to the register R0 shows 8 bits, the second-type instruction corresponding circuit 113 specifies the data length as 8 bits, and instruction 3 is decoded as an instruction for performing multiplication with the 8-bit data of each of the register R0 and the register R2 as calculation targets. Furthermore, the data length selection-use information corresponding to the register R2 is updated to a value 01b showing 16 bits, which is two times 8 bits (see t3 in FIG. 9).

(d) When the decoding unit 110 has then decoded instruction 4 that instructs transfer of the unspecified data length contents of the register R2 to the data memory 150, the decoding unit 110 decodes instruction 5. Instruction 5 instructs transferring 16-bit data from the data memory 150 to the register R1. Here, the data length selection-use information corresponding to the register R1 is updated by the first-type instruction corresponding circuit 112 to a value 01b showing 16 bits (see t5 in FIG. 9).

(e) Next, the decode unit 110 decodes instruction 6 that is an ext instruction relating to the register R0. Here, the data length selection-use information corresponding to the register R0 is updated by the first-type instruction corresponding circuit 112 to a value 01b showing 16 bits (see t6 in FIG. 9).

(f) The decoding unit 110 then decodes instruction 7 that instructs adding of unspecified data length contents of the register R0 and the contents of the register R1. Here, the addition is performed based on the data length of 16 bits shown by 01b that the second-type instruction corresponding circuit 113 determines by referring to the data length selection-use information corresponding to the register R0.

Instructions 8 and onwards are also successively decoded by the decoding unit 110.

### 2. Second Embodiment

The following describes a microprocessor 200 of a second embodiment of the present invention.

2-1. Overview

The microprocessor 200 of the second embodiment is the microprocessor 100 of the first embodiment that has been modified partially. As described, the microprocessor 100 of the first embodiment stores data length selection-use information, the pieces of which correspond to the general registers in the data length storage circuit 119 and are used to specify the data length relating to an instruction with an unspecified data length. In contrast, the microprocessor 200 of the second embodiment stores only a single piece of data length selection-use information in a data length storage circuit 219, together with validity information. The pieces of validity information correspond respectively to the general-purpose registers 120, and each show whether or not reference to the data length selection-use information is valid. The microprocessor 200 uses the combination of the one piece of data length selection-use information and the plurality of pieces of validity information to specify the data length relating to instructions that do not specify a data length.

Since the microprocessor 200 of the second embodiment does not have respective data length selection-use information for each general-purpose register, it is particularly suitable for executing programs such as those where the entire program or relatively large portions of the program basically handle data of a single length such as 8 bits or 16 bits.

2-2. Structure

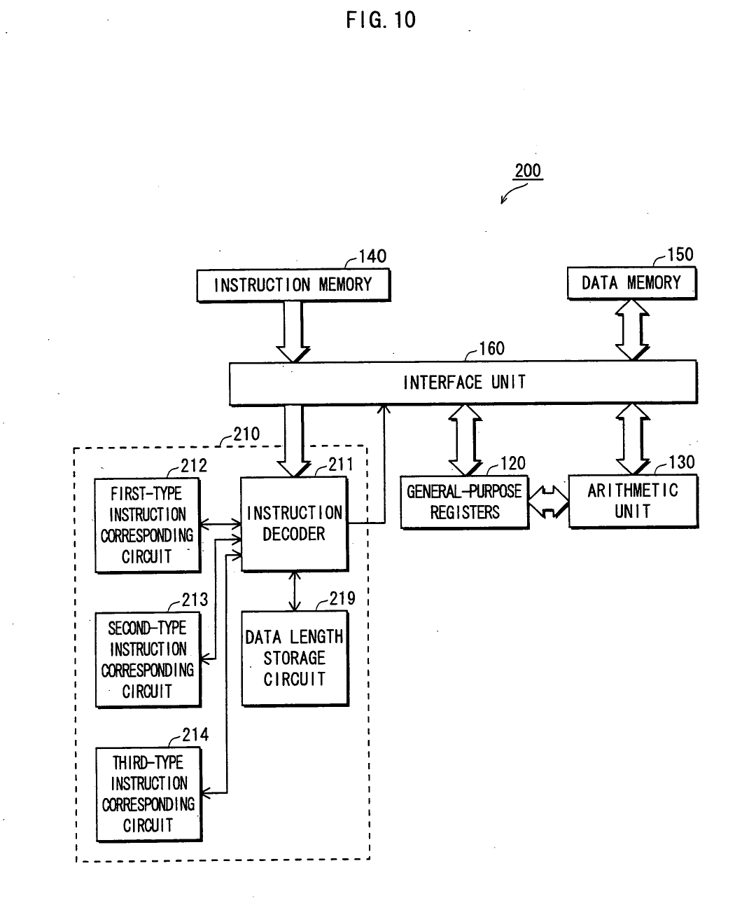

FIG. 10 is a structural diagram of the microprocessor 200 of the second embodiment of the present invention.

The microprocessor 200 differs from the microprocessor 100 in that the decoding unit 110 has been modified. As shown in FIG. 10, the microprocessor 200 has a decoding unit 210, the general-purpose registers 120, the arithmetic unit 130, the instruction memory 140, the data memory 150 and the interface unit 160. Note a description is omitted of the components that were described in the first embodiment.

The decoding unit 210 has a function of determining, based on each of instruction codes successively read from the instruction memory 140, control content for causing the arithmetic unit 130 and the interface unit 160 to operate in accordance with the instruction code, and transmitting a control signal to the interface unit 160 to have the control performed. In other words, the decoding unit 110 is a circuit having a function of decoding instructions. As shown in FIG. 10, the decoding unit 210 has an instruction decoder 211, a first-type instruction corresponding circuit 212, a second-type instruction corresponding circuit 213, a third-type instruction corresponding circuit 214 and a data length storage circuit 219.

The instruction decoder 211 is a circuit that executes various control necessary to decode.

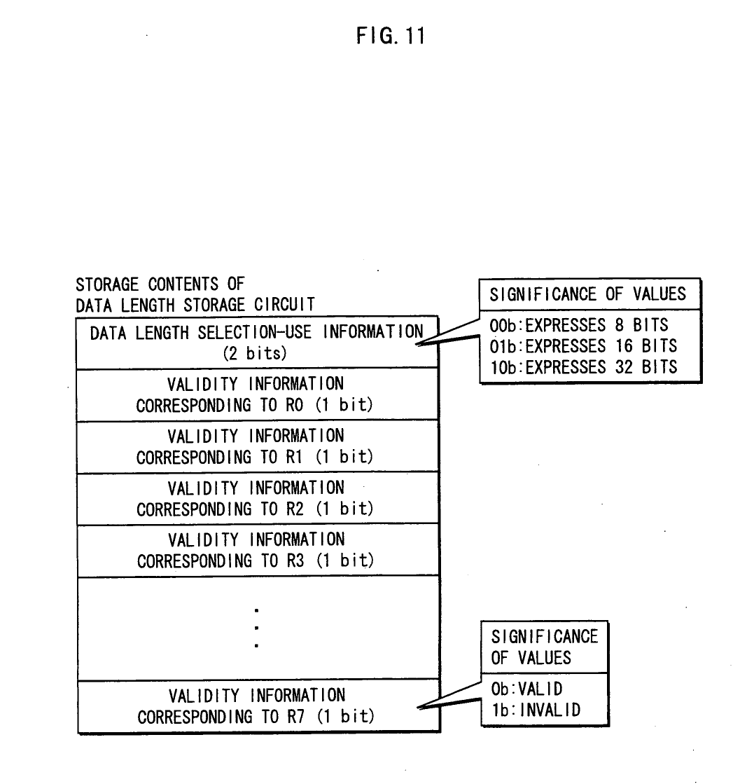

The data length storage circuit 219 is a storage circuit that stores single piece of data length selection-use information and a plurality of pieces of validity information. The piece of data length selection-use information shows a length of data that is a processing target of calculation, data transfer or the like. The pieces of validity information correspond respectively to the general-purpose registers 120. FIG. 11 shows the storage contents of the data length storage circuit 219. As shown in FIG. 11, in these one-bit pieces of validity information, a value 0b expresses validity, and a value 1b expresses invalidity.

The first-type instruction corresponding circuit 212 is a circuit having a function of, when the instruction code that is the decoding target is a first-type instruction (see FIG. 4), updating the contents of the data length storage circuit 219 in accordance with the contents of the first-type instruction.

The first-type instruction corresponding circuit 112 of the first embodiment that updates the data length selection-use information corresponding to the general-purpose register designated by a first-type instruction in accordance with the first-type instruction. In contrast, the first-type instruction corresponding circuit 212 of the second embodiment sets the piece of validity information corresponding to the general-purpose register designated by a first-type instruction to show valid, and then updates the data length selection-use information in accordance with the first-type instruction. This updating is performed regardless of which of the pieces of validity information was set to show valid.

The second-type instruction corresponding circuit 213 is a circuit that has a function of, when the instruction code that is the decoding target is a second-type instruction (see FIG. 5), referring to the contents of the data length storage circuit 219 to specify the length of data that is a target of processing corresponding to the instruction code of the second-type instruction, and conveying the specified data length to the instruction decoder 211 to cause the instruction decoder 211 to decode in accordance with the data length.

The second-type instruction corresponding circuit 213 differs from the second-type instruction corresponding circuit 113 of the first embodiment as follows. As described, in response to a second-type instruction, the second-type instruction corresponding circuit 113 of the first embodiment refers to the data length selection-use information corresponding to the general-purpose register where the processing target data is assumed to be stored, and selectively specifies the length of the processing target data of the second-type instruction. In contrast, the second-type instruction corresponding circuit 213 first refers to the piece of validity information corresponding to the general-purpose register where the processing target data is assumed to be stored, and then, only if the piece of validity information shows that reference to the data length selection-use information is valid, refers to the single piece of data length selection-use information to selectively specify the length of the processing target data of the second-type instruction.

The third-type instruction corresponding circuit 214 has a function of updating the validity information stored in the data length storage circuit 219, when the instruction code that is the decoding target is a third-type instruction. Third-type instructions are instructions that have a function of using storage contents of the general register as a value that indicates a memory address corresponding to the data memory 150, an example of a third-type instruction being an instruction for storing a certain memory address value in the register R1. In response to a third-type instruction, the third-type instruction corresponding circuit 214 updates the piece of validity information corresponding to the general-purpose register designated by the third-type instruction as the location where the memory address value is stored, such that the piece of validity information indicates invalidity.

2-3. Operations

The following describes operations by the microprocessor 200 having the described structure.

The microprocessor 200 performs the operations shown in FIG. 6 in the same way as the microprocessor 100, with the exception of the decoding unit 210 performing instruction interpreting processing that differs from that shown in FIG. 7 as follows.

(a) First, the instruction decoder 211 decodes an instruction read from the instruction memory 140.

(b) Next, the decoding unit 210 judges whether or not the instruction is a second-type instruction. When the instruction is judged to be a second-type instruction, and only if validity is shown by the piece of validity information corresponding to the general-purpose register designated by the second-type instruction as the location where the processing target data is stored, the second-type instruction corresponding circuit 213 specifies, as the length of the processing target data, the data length shown by the data length selection-use information, and conveys the data length to the instruction decoder 211. Having received the data length, the instruction decoder 211 further decodes the instruction in accordance with this received data length. Note that if the validity information corresponding to the general-purpose register shows that reference to the data length selection-use information is invalid, the second-type instruction corresponding circuit 213 specifies a predetermined length as the length of the processing target data, and conveys the specified data length to the instruction decoder 211. This predetermined length is a length that is necessary for designating a memory address, one example being 32 bits.

(c) The decoding unit 210 then judges whether or not the decoded instruction is a first-type instruction, and if the decoded instruction is judged to be a first-type instruction, the first-type instruction corresponding circuit 212 updates the data length selection-use information in accordance with the first-type instruction, and then updates the piece of validity information corresponding to the general-purpose register designated by the first-type instruction to show valid.

(d) Next, the decoding unit 210 judges whether or not the decoded instruction is a third-type instruction, and if the decoded instruction is judged to be a third-type instruction, the third-type instruction corresponding circuit 214 updates the piece of validity information corresponding to the general-purpose register designated by the third-type instruction to show invalid.

The decoding unit 210 repeats the described procedures (a) to (d) so as to perform them with respect to each instruction.

### 3. Third Embodiment

The following describes a microprocessor of a third embodiment of the present invention.

3-1. Overview

The microprocessor of the third embodiment is the microprocessor 200 of the second embodiment that has been modified partially. As described, the microprocessor 200 of the second embodiment, which stores in the data length storage circuit 219 a single piece of data length selection-use information as well as pieces of validity information corresponding to the general-purpose registers 120, updates the contents of the data length holding circuit 219 in accordance with first-type and third-type instructions, and uses the contents of the data length holding circuit 219 to specify the length of the processing target data of a second-type instruction. In contrast, the microprocessor of the third embodiment stores a single piece of data length selection-use information in the data length storage circuit, and does not store validity information. The microprocessor of the third embodiment performs no particular processing with respect to first-type and third-type instructions, but each time a NOP instruction is decoded, updates the piece of data length selection-use information for specifying the length of processing target data of a second-type instruction, such that the piece of data length selection-use information cyclically shows a data length of 8 bits, 16 bits, 32 bits, 8 bits, 16 bits, 32 bits, 8 bits, etc.

3-2. Structure

The microprocessor of the third embodiment (hereinafter referred to as the “modified microprocessor”) shares the structural components of the microprocessor 200 of the second embodiment (see FIG. 10) to an extent, but differs from the microprocessor 200 in that a third-type instruction corresponding circuit is omitted, a NOP instruction corresponding circuit is provided instead of a first-type instruction corresponding circuit, and the storage contents of the data length storage circuit are a single piece of data length selection-use information. Note that the instruction decoder causes the NOP instruction corresponding circuit to operate when a NOP instruction is decoded, and the NOP instruction corresponding circuit cyclically updates the contents of the data length selection-use information.

3-3. Operations

The following describes operations by the modified microprocessor.

The modified microprocessor performs the operations shown in FIG. 6 in the same way as the microprocessor 200, with the exception of instruction interpreting processing which has been modified as follows. Note that before commencing instruction interpreting processing for interpreting a program, the decoding unit sets the data length selection-use information to an initial value showing a predetermined data length such as 8 bits.

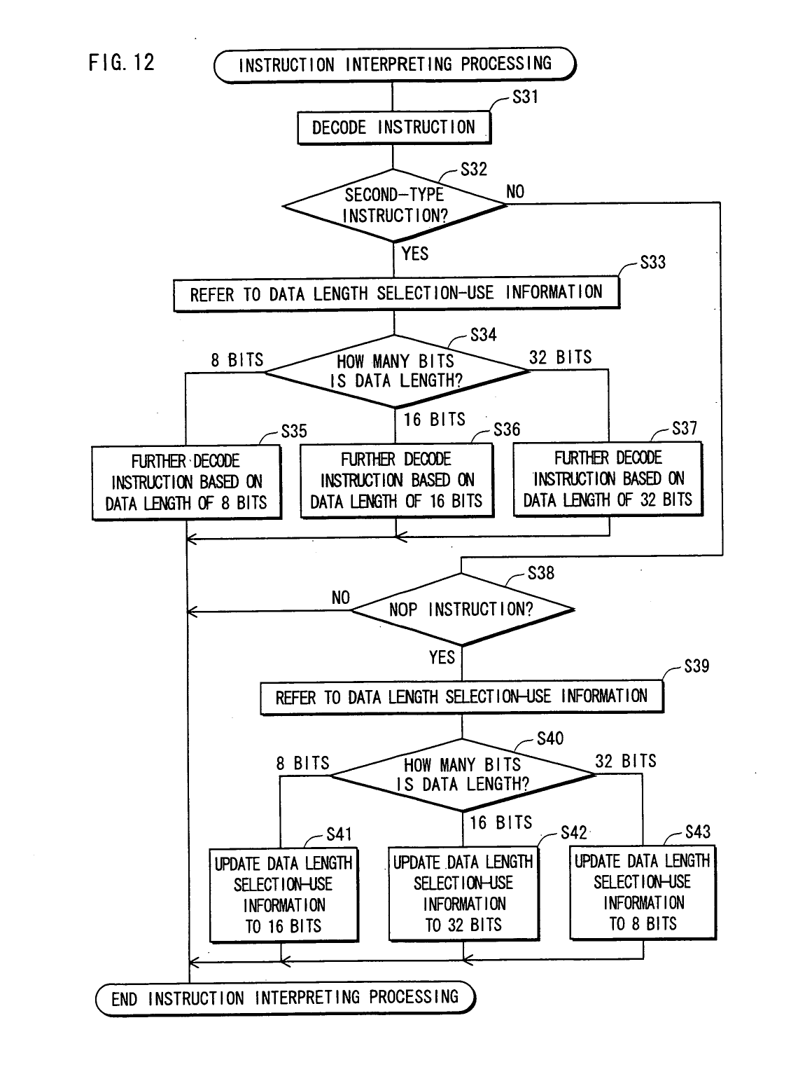

FIG. 12 is a flowchart showing instruction interpreting processing performed by the decoding unit of the modified microprocessor.

The decoding unit performs control for the instruction decoder to decode an instruction read from the instruction memory 140, in order to prepare for execution of the instruction (step S31). If the instruction is a second-type instruction (step S32), the decoding unit causes the second-type instruction corresponding circuit to operate. Note that in the decoding at the stage of step S31, control relating to data length is not performed for instructions with an unspecified data length.

The second-type instruction corresponding circuit refers to the data length selection-use information (step S33), specifies the data length (step S34), and conveys the data length to the instruction decoder. If the conveyed data length is 8 bits, the instruction decoder further decodes the instruction as an instruction whose processing target is 8-bit data (step S35) If the conveyed data length is 16 bits, the instruction decoder further decodes the instruction as an instruction whose processing target is 16-bit data (step S36). If the conveyed data length is 32 bits, the instruction decoder further decodes the instruction as an instruction whose processing target is 32-bit data (step S37).

If the read instruction is not a second-type instruction but a NOP instruction (step S38), the instruction decoder causes the NOP instruction corresponding circuit to operate, and if the data length selection-use information shows 8 bits, the NOP instruction corresponding circuit updates the data length selection-use information to show 16 bits (steps S40 and S41). On the other hand, if the data length selection-use information shows 16 bits, the NOP instruction corresponding circuit updates the data length selection-use information to show 32 bits (steps S40 and S42). Furthermore, if the data length selection-use information shows 32 bits, the NOP instruction corresponding circuit updates the data length selection-use information to show 8 bits (steps S40 and S43).

4. Supplementary Remarks

The microprocessor of the present invention is by no means limited to the described first to third embodiments. The following are examples of possible modifications to the microprocessor of the present invention.

(1) In each of the described embodiments, the microprocessor specifies data length that reflects the data length selection-use information relating to data stored in the eight general-purpose registers (registers R0 to R7). However, the number of general-purpose registers in the microprocessor is not limited to being eight. Furthermore, the microprocessor may have a structure in which data length selection-use information is used to specify the length of stored data with respect to only some of the general-purpose registers.

Furthermore, although the general-purpose registers in the described embodiments are each of a size capable of storing 32 bits of data, the registers are not limited to 32 bits, and may, for instance, be 16-bit registers or 64-bit registers. The data length selection-use information may be expressed in accordance with the size of the registers, more specifically, in accordance with the possible lengths of data relating to processing targets of the various calculations and data transfer. For instance, if the only possible data lengths are 8 bits and 16 bits, it is sufficient for the data length selection-use information to be configured such that two lengths can be identified.

(2) The microprocessor may be structured so as to perform control with reduced power consumption. More specifically, when the decoding unit decodes an instruction, after the length of the processing target data of a decoded instruction, the microprocessor may control such that circuits operate only to an extent necessary for the calculation processing or transfer processing of data of the specified length. For instance, the microprocessor may be structured such that, when it is specified that a general-purpose register capable of storing 32 bits of data is storing data that is only 8 bits in length, the microprocessor saves on the power that would be required for maintaining or inputting/outputting the remaining 24 bits of data in the general-purpose register.

(3) Each of the microprocessors shown in the first to third embodiments may have a pipeline structure in which each of instruction reading (fetching), instruction interpreting (decoding) and execution are separate pipeline stages.

(4) In the first embodiment, an example is given of the data length selection-use information being updated to show a doubled data length when a mul instruction is decoded, however one alternative to this is as follows. Suppose the example of decoding a mul instruction for multiplying the contents of the register R0 and the register R1 and storing the result in the register R1. Here, the data length selection-use information corresponding to the register R1 may be updated so as to newly show the sum of the respective data lengths shown by the data length selection-use information corresponding to the register R0 and the data length selection-use information corresponding to the register R1 (i.e. the data length that was shown by data length selection-use information prior to the update). In addition to mul instructions, other instructions for which the length of calculation target data and the length of calculation result data differ may be set as first-type instructions, and the data length selection-use information may be updated by the first-type instruction correspondence circuit in accordance with these first-type instructions. These instructions include instructions for division and instructions for bit manipulation.

Included in the first-type instructions may be data storage instructions that instruct storing of one length of data to the register, and instructions that instruct storing of another length of data to the register. Example of such instructions include: a mov instruction that instructs storing 8-bit immediate data in the general-purpose register, a mov instruction that instructs storing 16-bit immediate data in the general-purpose register, a mov instruction that instructs storing 8 bits of data in the memory to the general-purpose register, and a mov instruction that instructs storing 16 bits of data in the memory to the general-purpose register. Here, the first-type instruction corresponding circuit should be structured to perform processing in accordance with the instructions.

(5) In the second embodiment, the third-type instructions are instructions for instructing storage of a 32-bit (4-byte) memory address value in a general-purpose register. However, this memory address value is not limited to being 32 bits, and may be 16 bits. If the memory address value is 16 bits, the third-type instruction corresponding circuit should be structured so as to update the data length selection-use information to a value showing 16 bits, in accordance with the third-type instruction.

(6) In the third embodiment, an example was given of a NOP instruction which is conventionally included in an instruction set as an instruction for instructing no particular control processing, being given a function of cyclically updating the data length selection-use information. However, the instruction set may include various specific instructions that explicitly instruct updating of the data length selection-use information to a value showing a specific data length. Examples of such specific instructions are: a specific instruction that instructs updating the data length selection-use information to show 8 bits, a specific instruction that instructs updating the data length selection-use information to show 16 bits, and a specific instruction that instructs updating the data length selection-use information to show 32 bits. Here, the microprocessor may be structured so as to update the data length selection-use information in accordance with the specific instruction. Note that the NOP instruction may be set as a first-type instruction, and the first-type instruction corresponding circuit may update the data length selection-use information cyclically as descried above in accordance with the NOP instruction.

The decoding units in the first and second embodiments may also be structured so as to update the data length selection-use information in accordance with the NOP instruction shown in the third embodiment, or to explicitly update the data length selection-use information to show a specific data length in accordance with the specific instructions.

Furthermore, a program may be created that, if for instance the data length selection-use information shows 8 bits and is to be updated to show 32 bits in the third embodiment, causes the microprocessor to execute two NOP instructions consecutively in that portion of the program. In this way, the microprocessor may be structured such that the data length selection-use information can be updated to show a specific value even if the instructions are specific instructions, not NOP instructions, by arranging the specific instructions in a predetermined set pattern.

Although the present invention has been fully described by way of examples with reference to the accompanying drawings, it is to be noted that various changes and modification will be apparent to those skilled in the art. Therefore, unless otherwise such changes and modifications depart from the scope of the present invention, they should be construed as being included therein.

What is claimed is:

1. A microprocessor that successively reads instructions, and interprets and executes each read instruction, comprising:
a storage unit operable to store data length selection-use information showing a length of processing target data;
a decoding unit operable to successively perform instruction interpreting processing with respect to the instructions to specify, for each instruction, contents of instruction executing processing to be performed in accordance with the instruction; and
an execution unit operable to perform, with respect to each instruction, the instruction executing processing in accordance with the contents specified as a result of the instruction interpreting processing for the instruction, wherein
when a target of the instruction interpreting processing is any one of first-type instructions, the decoding unit updates the stored data length selection-use information in accordance with the first-type instruction, and
when the target of the instruction interpreting processing is anyone of second-type instructions, the decoding unit selects a length of processing target data of the second-type instruction in accordance with the stored data length selection-use information, and performs the instruction interpreting processing in accordance with the selected length.

2. The microprocessor of claim 1, wherein
the first-type instructions include a data storage instruction that instructs storing data of a first length to a register, and a data storage instruction that instructs storing data of a second length to a register, and
when the target of the instruction interpreting processing is either of the data storage instructions, the decoding unit updates the stored length selection-use information so as to show the one of the first and second lengths that pertains to the one of the data storage instructions that is the target.

3. The microprocessor of claim 1, wherein
the first-type instructions include (i) an instruction that instructs setting of an n-bit value in a register, (ii) an instruction that instructs setting of a 2n-bit value in a register, (iii) an instruction that instructs transfer of n bits of data from a memory to a register, and (iv) an instruction that instructs transfer of 2n bits of data from the memory to a register, and
when the target of the instruction interpreting processing is the instruction that instructs setting of an n-bit value in a register, the decoding unit updates the stored data length selection-use information to show n bits,
when the target of the instruction interpreting processing is the instruction that instructs setting of a 2n-bit value in a register, the decoding unit updates the stored data length selection-use information to show 2n bits,
when the target of the instruction interpreting processing is the instruction that instructs transfer of n bits of data from a memory to a register, the decoding unit updates the stored data length selection-use information to show n bits, and
when the target of the instruction interpreting processing is the instruction that instructs transfer of 2n bits of data from a memory to a register, the decoding unit updates the stored data length selection-use information to show 2n bits.

4. The microprocessor of claim 1, wherein
at least one of the instructions is a multiplication instruction that is included in both the first-type instructions and the second-type instructions, and
when the target of the instruction interpreting processing is the multiplication instruction, the decoding unit selects a length of processing target data of the multiplication instruction in accordance with the stored data length selection-use information to perform the instruction interpreting processing in accordance with the selected length, and updates the stored data length selection-use information to show a predetermined value.

5. The microprocessor of claim 1, wherein
the data length selection-use information selectively shows one of a plurality of lengths, and
each time the decoding unit performs the instruction interpreting processing for any of the first-type instructions, the decoding unit updates the data length selection-use information so as to show a next one of the plurality of lengths in a predetermined cyclic order of the plurality of lengths.

6. The microprocessor of claim 1, further comprising a plurality of registers that are able to be designated as storage locations of processing target data by instructions,
wherein the storage unit stores a plurality of pieces of the data length selection-use information that correspond respectively to the plurality of registers,
the first-type instruction is an instruction that instructs storing of data of a certain length to a certain one of the registers,
the second-type instruction is an instruction that instructs performing calculation processing with respect to, as the processing target data, data stored in a certain one of the registers and being of a certain length, and
when the target of the instruction interpreting processing is the first-type instruction, the decoding unit updates the piece of data length selection-use information corresponding to the register to which storing of data is instructed by the first-type instruction, and
when the target of the instruction interpreting processing is the second-type instruction, the decoding unit selects a length of the processing target data of the second-type instruction in accordance with the piece of data length selection-use information corresponding to the register designated by the second-type instruction as storing the processing target data, and specifies the contents of the instruction executing processing for the second-type instruction such that the calculation processing is performed with respect to the selected length's worth of the processing target data.

7. The microprocessor of claim 1, further comprising a plurality of registers that are able to be designated as storage locations of processing target data by instructions,
wherein the storage unit further stores a plurality of pieces of validity information that correspond respectively to the plurality of registers, each piece of validity information showing whether to treat the data length selection-use information as valid or invalid in the instruction interpreting processing,
the first-type instruction is an instruction that instructs storing of data of a certain length to a certain one of the registers,
the second-type instruction is an instruction that instructs performing calculation processing with respect to, as the processing target data, data stored in a certain one of the registers and being of a certain length, and
when the target of the instruction interpreting processing is the first-type instruction, in addition to updating the data length selection-use information in accordance with the first-type instruction, the decoding unit updates, to show valid, the piece of validity information corresponding to the register to which storing of data is instructed by the first-type instruction,
when the target of the instruction interpreting processing is a third-type instruction, the decoding unit updates, to show invalid, a piece of validity information corresponding to a certain one of the registers, in accordance with the third-type instruction, and
when the target of the instruction interpreting processing is the second-type instruction,
(a) (i) if the piece of validity information corresponding to the register designated by the second-type instruction as storing the processing target data shows valid, the decoding unit selects a length of the processing target data in accordance with the data length selection-use information, (ii) if the piece of validity information corresponding to the register designated by the second-type instruction as storing the processing target data shows invalid, the decoding unit selects a predetermined length as a length of the processing target data, and
(b) the decoding unit specifies the contents of the instruction executing processing for the second-type instruction such that the calculation processing is performed with respect to the selected length's worth of the processing target data.
